(19) United States
(12) Patent Application Publication
(10) Pub. No.: US 2013/0211862 A1
(43) Pub. Date: Aug. 15, 2013

(54) AGGREGATED ADVERTISING

(71) Applicants: John G. Musial, Newburgh, NY (US); Abhinay R. Nagpal, Pune (IN); Sandeep R. Patil, (US); Carolyn A. Whitehead, Norwich, CT (US)

(72) Inventors: John G. Musial, Newburgh, NY (US); Abhinay R. Nagpal, Pune (IN); Sandeep R. Patil, (US); Carolyn A. Whitehead, Norwich, CT (US)

(73) Assignee: INTERNATIONAL BUSINESS MACHINES CORPORATION, Armonk, NY (US)

(21) Appl. No.: 13/396,177

(22) Filed: Feb. 14, 2012

(51) Int. Cl. G06Q 30/02; G06Q 10/02

(52) U.S. Cl. 705/5

(57) ABSTRACT

A server may receive a first check-in corresponding to at least one person, wherein a check-in is a indication of presence. The server may receive a second check-in to form an aggregation of people. The server may characterize the aggregation based on the cumulative characteristics selected from at least one of the group consisting of age, marital status, and parental status associated with at least one of the first check-in and second check-in to form an aggregated population characteristic. The server may select at least one advertisement based on the aggregated population characteristic. The server may dispatch the at least one advertisement.

### BACKGROUND

The present invention relates to a computer implemented method, data processing system, and computer program product for distributing information and more specifically to distributing advertisements to receptive audiences.

Airports regularly provide television displays to provide some relief for travelers who are awaiting their time to board an airplane. Recent years of shifting security requirements have caused travelers to arrive at their assigned gates early, leaving many opportunities to advertise to them.

Other venues provide opportunities to locate a captive audience and assess their receptiveness to various advertisements. To date, very little has been done to determine the various characteristics of these audiences and attempt to cater to their specific needs.

### SUMMARY

According to one embodiments of the present invention, a computer implemented method, data processing system, or computer program product is disclosed to select advertising. A server may receive a first check-in corresponding to at least one person, wherein a check-in is an indication of presence. The server may receive a second check-in to form an aggregation of people. The server may characterize the aggregation based on the cumulative characteristics selected from at least one of the group consisting of age, marital status, and parental status associated with at least one of the first check-in and second check-in to form an aggregated population characteristic. The server may select at least one advertisement based on the aggregated population characteristic. The server may dispatch the at least one advertisement.

### BRIEF DESCRIPTION OF THE SEVERAL VIEWS OF THE DRAWINGS

FIG. 1 is a block diagram of a data processing system in accordance with an illustrative embodiment of the invention;

FIG. 2 is an illustrative environment of data processing systems and other equipment in and around an aggregation of people in accordance with an illustrative embodiment of the invention;

FIG. 3 is an exemplary repository that relates destination and/or target demographics to advertisements in accordance with an illustrative embodiment of the invention; and

FIG. 4 is a flowchart that describes how one or more servers may collect and periodically discard information concerning a dynamically changing aggregation of people and deliver suitable advertising in accordance with an illustrative embodiment of the invention.

### DETAILED DESCRIPTION

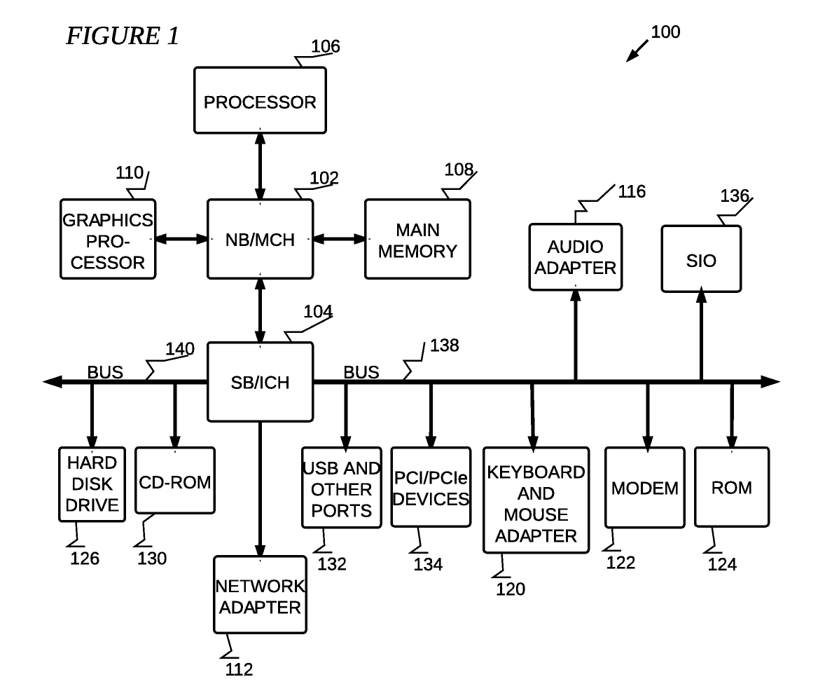

With reference now to the figures and in particular with reference to FIG. 1, a block diagram of a data processing system is shown in which aspects of an illustrative embodiment may be implemented. Data processing system 100 is an example of a computer, in which code or instructions implementing the processes of the present invention may be located. In the depicted example, data processing system 100 employs a hub architecture including a north bridge and memory controller hub (NB/MCH) 102 and a south bridge and input/output (I/O) controller hub (SB/ICH) 104. Processor 106, main memory 108, and graphics processor 110 connect to north bridge and memory controller hub 102. Graphics processor 110 may connect to the NB/MCH through an accelerated graphics port (AGP), for example. Processor 106 can be a hardware processor.

In the depicted example, local area network (LAN) adapter 112 connects to south bridge and I/O controller hub 104 and audio adapter 116, keyboard and mouse adapter 120, modem 122, read only memory (ROM) 124, hard disk drive (HDD) 126, CD-ROM drive 130, universal serial bus (USB) ports and other communications ports 132, and PCI/PCIe devices 134 connect to south bridge and I/O controller hub 104 through bus 138 and bus 140. PCI/PCIe devices may include, for example, Ethernet adapters, add-in cards, and PC cards for notebook computers. PCI uses a card bus controller, while PCIe does not. ROM 124 may be, for example, a flash binary input/output system (BIOS). Hard disk drive 126 and CD-ROM drive 130 may use, for example, an integrated drive electronics (IDE) or serial advanced technology attachment (SATA) interface. A super I/O (SIO) device 136 may be connected to south bridge and I/O controller hub 104.

An operating system runs on processor 106, and coordinates and provides control of various components within data processing system 100 in FIG. 1. The operating system may be a commercially available operating system such as Microsoft® Windows® XP. Microsoft and Windows are trademarks of Microsoft Corporation in the United States, other countries, or both. An object oriented programming system, such as the Java™ programming system, may run in conjunction with the operating system and provides calls to the operating system from Java™ programs or applications executing on data processing system 100. Java™ is a trademark of Sun Microsystems, Inc. in the United States, other countries, or both.

Instructions for the operating system, the object-oriented programming system, and applications or programs are located on computer readable tangible storage devices, such as hard disk drive 126, and may be loaded into main memory 108 for execution by processor 106. The processes of the embodiments can be performed by processor 106 using computer implemented instructions, which may be located in a memory such as, for example, main memory 108, read only memory 124, or in one or more peripheral devices.

Those of ordinary skill in the art will appreciate that the hardware in FIG. 1 may vary depending on the implementation. Other internal hardware or peripheral devices, such as flash memory, equivalent non-volatile memory, and the like, may be used in addition to or in place of the hardware depicted in FIG. 1. In addition, the processes of the illustrative embodiments may be applied to a multiprocessor data processing system.

In some illustrative examples, data processing system 100 may be a personal digital assistant (PDA), which is configured with flash memory to provide non-volatile memory for storing operating system files and/or user-generated data. A bus system may be comprised of one or more buses, such as a system bus, an I/O bus, and a PCI bus. Of course, the bus system may be implemented using any type of communications fabric or architecture that provides for a transfer of data between different components or devices attached to the fabric or architecture. A communication unit may include one or more devices used to transmit and receive data, such as a modem or a network adapter. A memory may be, for example, main memory 108 or a cache such as found in north bridge and memory controller hub 102. A processing unit may include one or more processors or CPUs. The depicted example in FIG. 1 is not meant to imply architectural limitations. For example, data processing system 100 also may be a tablet computer, laptop computer, or telephone device in addition to taking the form of a PDA.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present invention may be embodied as a system, method or computer program product. Accordingly, one or more embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The illustrative embodiments permit collecting vital statistics of a checked-in aggregation of people to better characterize either their demographic information or to assess their immediate and post-travel needs. This collecting of vital statistics is periodically refined by occasional checking out of people, such as travelers embarking a plane or by adding updated flight timeliness details to allow selection of advertising delivered in the vicinity of the aggregation of people. Accordingly, people can become aware of delightful services that can make their trip or other activity more enjoyable.

Further, embodiments may permit routine refinement of the characterization of a group of people in a manner that reflects who has checked-in to an aggregation of people, and who has checked-out, or at least presumptively checked-out. As such, one or more embodiments may adjust the type of advertising in response to the changing characterization, so that when a characterization shows a propensity of a certain class of person, then advertisements that cater to that type of person can be selected for rendering in the environment where such an aggregation appears. Accordingly, less targeted advertising can be omitted from any rotation of advertisements in response to the changing characterization.

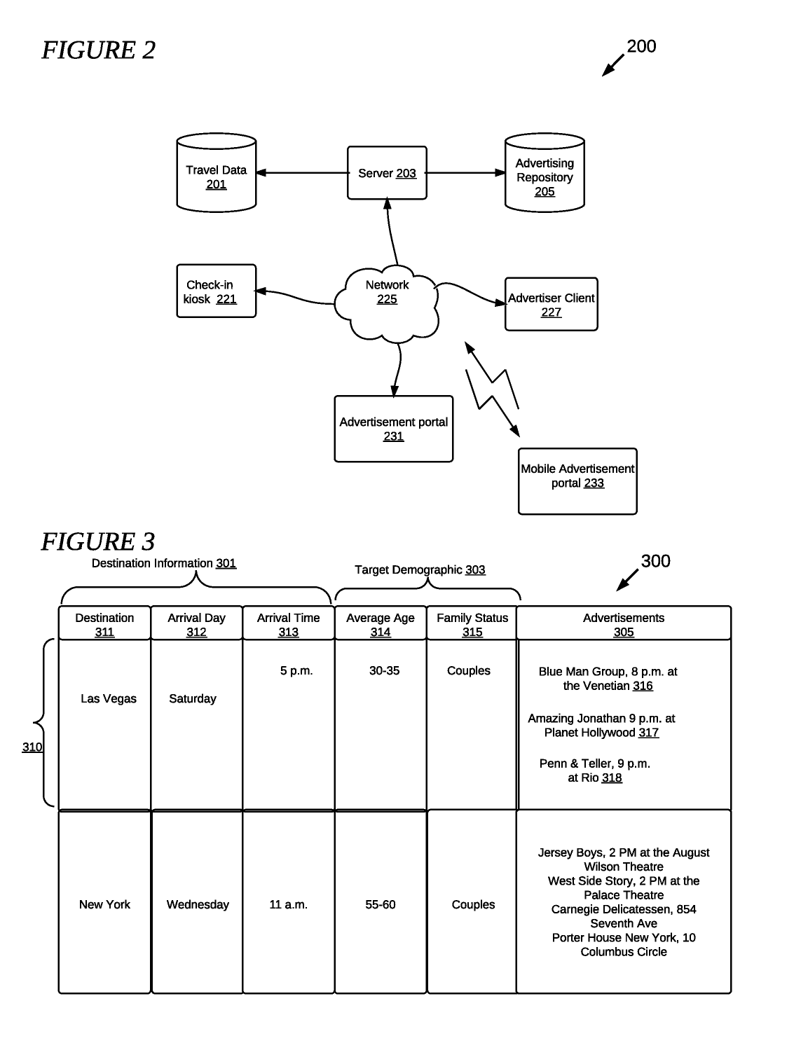

FIG. 2 is a block diagram of an illustrative environment of data processing systems and other equipment in and around an aggregation of people in accordance with an illustrative embodiment of the invention. Such an embodiment may be applied within an airport setting. Nevertheless, the embodiment is broadly applicable to health clubs, aggregations of people awaiting to embark a ferry, and entertainment venues where people congregate. In other words, the embodiment works with any aggregation of people. An aggregation of people is any clustering of people associated with a common service. A common service can be common carriage by a commercial means of transportation. A commercial means of transportation can include aircraft travel, train service, boat travel, and the like.

The components shown in FIG. 2 form advertising network 200. Initially, travelers may build a repository of data in coordination with an airline. Upon booking a flight, the airline can produce travel data 201 stored in hardware accessible to server 203. Travel data that is stored includes vital statistics concerning one or more travelers who travel together. A vital statistic is an interesting fact about a person. It can include physical dimensions and geometry of a body. It can include hair coloring and marital status. It can include additional relationship statuses beyond marital status. A vital statistic can be entered when booking a flight for plural people on a single record locator or, alternatively, the vital statistic can be looked up based on previously obtained data from a person. Server 203 can be constructed, for example, as a data processing system 100 of FIG. 1.

Server 203 can access advertisements that are cross-referenced to demographic and other information in advertising repository 205. Server 203 can routinely collect data via network 225 pertaining to check-ins and available advertisement portals. An advertisement is any audio, visual or combination that is stored to a computer renderable file. The computer renderable file may be accessed by reference to a serial number that corresponds to the computer renderable file. Accordingly, the advertisement may be the actual computer renderable file, or the reference to the computer renderable file.

An advertisement portal is an audio and/or display device that can render advertisements perceptible to people nearby. The advertisement portal can be a computer client implemented using hardware of a data processing system, such as data processing system 100 of FIG. 1. The advertisement portal can coordinate with server 203 to display and/or play back advertisements in a manner that suits and delights a significant part of an aggregation of people. Advertisement portal 231 can be one of several that are arranged within or near a waiting area for an airport gate.

Though advertisement portal 231 may be fixed to a wall or ceiling or other suitable structure of the airport, further advertising can be delivered from a mobile advertisement portal, such as mobile advertisement portal 233. A mobile advertisement portal can be advertising placed on a service vehicle and arranged to obtain connectivity to server 203 via radio transceivers. A service vehicle associated with a flight is any vehicle that serves the common carrier at an airport in furtherance of a specific flight departure. These service vehicles can include fuel trucks, food and beverage delivery trucks, baggage handling equipment, and the like.

Advertiser client 227 is a client that may be arranged using a data processing system according to FIG. 1. The advertising client may deliver to server 203 advertisements and target demographic descriptions that can be used to locate and select such advertisements from a plurality of advertisements stored (or otherwise referenced) in advertising repository 205. Accordingly, advertiser client 227 may permit transactions to occur between an airline and advertisers so that the airline can receive orders. Such orders direct that the airline, or other service provider, renders advertising to aggregations of people under conditions prescribed by the client, whom desires their offerings to be advertised.

A check-in is an indication that a person has reached a threshold of a service-provider's facility. Additionally, the check-in can be a conscious or unconscious indication of presence of a person. The threshold can be plural check-in points and may not necessarily be at the ingress of a building.

A check-out is the act of sensing a person's departure or otherwise unavailability for commercial advertisements. A check-out can include individualized registration that a person is leaving. On the other hand, a check-out can include a registration that, with respect to people boarding a plane, the plane doors are all shut, or that the jet-way or other boarding device has been retracted from the aircraft. Check-out can include the reading of an identifier of the person. An identifier of a person can be an identity card. An identifier can be a personal-identification-number entered to a terminal.

Check-in kiosk 221 may be one of several arranged at the airport that permit a person to signal their arrival, provide credentials, and order selected services. A check-in kiosk, at a minimum, registers the arrival of a person, provided that person can be identified. In addition, the check-in kiosk may detect departure of a person. The arrival and departure of a person signal the addition of the person to the aggregation of people and the removal of the person from the aggregation of people, respectively. Accordingly, the aggregation of people provides a rough geographic localization of the grouping of people on the basis of check-ins and check-outs. The check-in status of a person can persist even if that person detours into a restroom, nearby restaurant, or is otherwise detained.

Detection of a person's presence, and thereby check-in, may occur via password or identifier entry, scanned bar-code, radio frequency identifiers, or any other localized identification mechanism. Check-in kiosk 221 may be one of several that permit a person to be detected at a periphery of a service-provider's facility.

Alternative versions of a check-in kiosk can be implemented as an application or app on a mobile handset, popularly known as a smart-phone. As such, a person may use their smart-phone to check in with a record locator or other identifier, at least in the old fashioned sense that the person indicates their intention to use the service, such as a flight, in a short period, such as, for example, 24 hours. After or concurrent with the old-fashioned check-in, responsive to a location based service reporting sufficient proximity to the service provider, the carrier of the mobile handset may be reported as checked-in to server 203 in FIG. 2, at least in the novel sense described herein.

A still further variant of the check-in kiosk can be the combined operation of the use of an internet connected terminal to allow a person to check-in, in the old-fashioned sense, that they intend to fly on a specific flight, within, for example, 24 hours. In which case, a further threshold detection of that person can be registered as the novel check-in, for example, by a network detector that determines passage through a security check-point corresponding to the flight for which the person previously, and old-fashionedly, checked-in.

FIG. 3 is an exemplary repository that relates destination and/or target demographics to advertisements in accordance with an illustrative embodiment of the invention. The repository can be populated with advertisements that are cross-referenced to conditions or other optimal descriptions of suitable times to display the advertisements, as may be negotiated via a client using advertiser client 227 of FIG. 2. The advertisements in repository 300 can be stored to repository 205 of FIG. 2. The advertisements may be preferentially played on the condition that a flight associated with a destination, stated therein, is not delayed or cancelled.

A destination as shown in destination column 311 may have multiple rows describing suitable advertisements, for example, for multiple service providers associated with the destination. Moreover, the advertisements can be limited to specific arrival dates and arrival times depicted in columns: arrival day 312 and arrival time 313. Additional limitations or preferences can be expressed per row, such as average age 314 and relationship status 315. A relationship status can be an indication of a type of relationship that a person experiences with a second person. Some examples include, ‘parent’, ‘sister’, ‘significant other’, spouse, among others. In addition to the specified arrival day and arrival time shown, each row may specify a range of dates and times.

Advertisement row 310 specifies three advertisements, namely, Blue Man Group 316, Amazing Jonathan 317 and Penn & Teller 318. These may be specified by a file name, a serial number, or the like. The actual storage of the advertisement can be such that it is at a repository, in an advertisement portal, or anyplace else accessible to network 225 (which may be the Internet) of FIG. 2. Accordingly, a direct or indirect reference to the storage location may be sufficient to couple the advertisement to the associated conditions shown in destination information 301 and target demographic 303. Thus, advertisements 305 may be stored as a reference in the repository.

A target demographic description is one or more metrics that may be matchable, or at least approach in similarity, to a group of people (aggregation). The target demographic description is a description, by way of the metrics, of a preferred type or class of customer or prospective customer that an advertiser wishes to expose to the advertisement.

A destination information is details concerning at least one stop or transit point on a route or itinerary. The destination information can be an international airport code, a train station name, a street address, and the like. A vendor location is a location of at least one vendor outlet. The vendor location can be destination information. The vendor location can be destination information that is associated with a destination airport by virtue of the vendor location being within a city served by the destination airport.

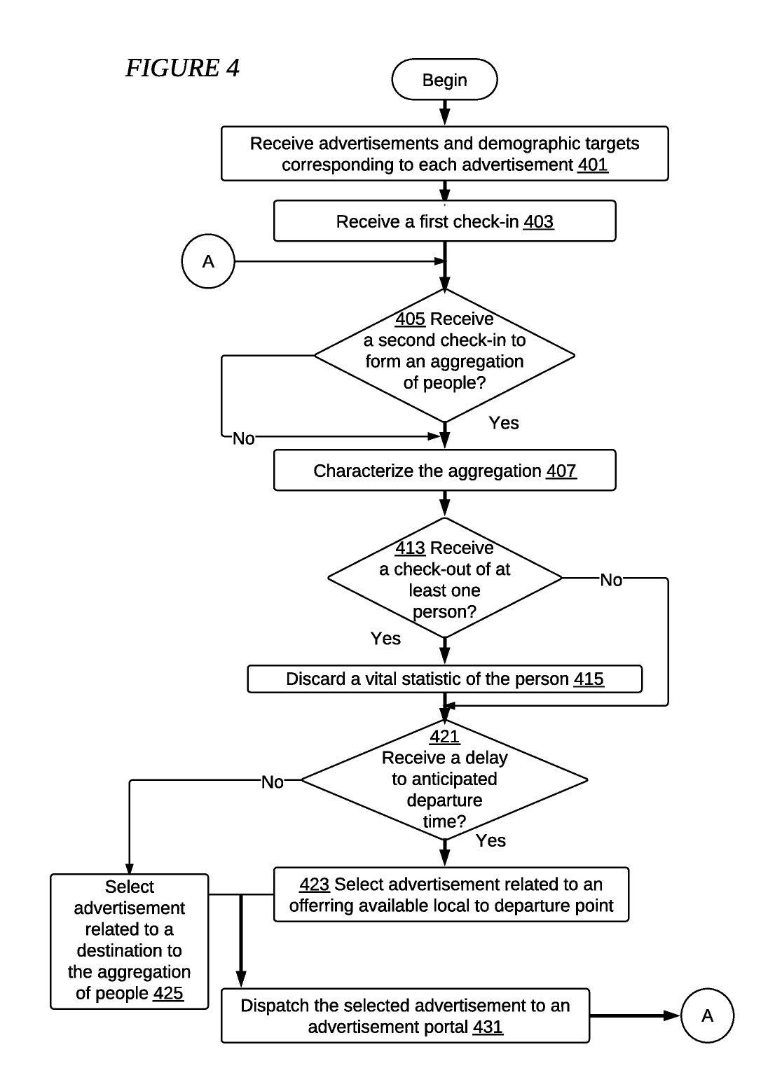

FIG. 4 is a flowchart that describes how one or more servers may collect and periodically discard information concerning a dynamically changing aggregation of people and deliver suitable advertising in accordance with an illustrative embodiment of the invention.

Initially, a server may receive advertisements and demographic targets corresponding to each advertisement (step 401). The advertisements may be correlated to the target demographic and/or destination information to form, for example, table 300 of FIG. 3. Accordingly, there are a number of potential advertisements available to be served or otherwise transmitted within advertising network 200.

Next, the server may receive a first check-in (step 403). The first check-in may form or add to an aggregation of people. Next, the server may receive a second check-in (step 405). Each of first-check in and second-check in includes, at least in airline-based embodiments, the obtaining of an associated flight detail. A flight detail is particular information concerning a flight. The flight details can include a destination, a duration, an indication of the kinds of meals and refreshments served aboard, and the like. Other forms of flight details can be arrival time, flight identifier and delay status. A detail can include the specific people that have checked-in. The check-in can include receiving a record locator or other reference to identify a person or the persons in a party with a specific flight.

A record locator is a key used by a common carrier to identify a passenger or group of passengers that travel together. The record locator can also be used as a key to locate travel details of the passenger or passengers from a travel repository. Relying on the record locator, the server can look up vital statistics from a repository based on the record locator for at least one person.

Having one or more people checking-in relative to a flight, the server can characterize the aggregation of people (step 407). Such a characterization may be based on the cumulative characteristics selected from at least one of the group consisting of age, marital status associated with the at least one first check-in to form an aggregated population characteristic. Further characterizing can also be based on a second and later check-ins.

An aggregated population characteristic can be based on two sub-steps. A first step can include the server looking up a target demographic for each checked-in person, as well as a destination information. Each person or destination information may be looked up with reference to travel data 201 of FIG. 2 available to the airline that may own or operate the server. The aggregated population characteristic can be a multi-dimensional description of the aggregation of people. Each dimension can be formed/measured as a cumulative characteristic. A cumulative characteristic is a value assigned to a group of people (or aggregation) that summarizes that group's demographics, destination or other motivation according to a metric. A metric is a characteristic associated with a person or persons. A metric can be a demographic quality of the person. A metric can be a destination of the person. For example, in forming a cumulative characteristic for three people who are aged 10, 20 and 30, the cumulative characteristic can be their average age of 20. Alternatively, in a group of five people where two are married to each other, two are in a committed relationship with each other, and one is single, the cumulative characteristic can be the relative proportion of each class of person as described by each person's relationship status. In this example, 40% are married, 40% are in a committed relationship, and 20% are single. Thus, the triplet of percentages would form a cumulative characteristic, which can form a component to the greater aggregated population characteristic.

A relationship status may be obtained from an online registry. An online registry is a registry that identifies relationships between people, for example, as may be self-reported and acknowledged between two people. An example of an online registry is Facebook™ online service. Facebook is a trademark of Facebook, Inc. Further online registries may be self-developed and maintained as part travel data 201 of FIG. 2. Details of a traveler's relationship can be collected from such travel data. On the other hand, where permitted, server 203 of FIG. 2 may transmit a person's identity, for example their name, and thereby solicity a relationship status from Facebook online service. As such, for people who have a ‘spouse’ or a ‘significant other’ relationship with any other fellow travelers, the server 203 of FIG. 2 can identify such people as ‘a couple’ and adjust advertising taking such information into account.

Next, the server may receive a check-out of at least one person (step 413). The check-out can include reading an identifier of the person. Alternatively, the check-out can be a flight status of a flight. A flight status is the status of a particular flight in relation to its normally scheduled departure time. The status can be ‘cancelled’. The status can be an indication of time delayed. In addition, the status can be an indication that the gate is closed, as may occur when the aircraft cabin is closed, or when the jet-way is refracted. Such details can be reported to the server by airline personnel.

If a person checks-out, the server may discard the vital statistics of that person (step 415). Thus, the server may modify the characterization of the aggregation accordingly.

In response to a negative result at step 413, the server may receive a delay to an anticipated departure time (step 421). The anticipated departure time can be the regularly scheduled departure time of the aircraft. However, equipment failures occur, bad weather causes congestion, and flight crews can be delayed reaching a gate assigned for a particular flight. Accordingly, a flight's departure status can change. A departure status is a status of a particular mode of transportation in terms of its expected timeliness as compared to its scheduled departure time. In other words, inclement weather, equipment breakdowns and the attendant delays associated with them can result in a predicted delay. The departure status can be provided by a dispatcher, mechanic or any other authorized person of the common carrier. The departure status can be provided to a data processing system for distribution as needed. An airline authority can be the mechanic or other authorized person of the common carrier who owns or controls the flight. Thus, any departure status that indicates the flight is delayed can be received by the server as a delay to the anticipated departure time. For example, the delay status can be a number of minutes as reported by at least one airline authority.

If such a delay is received, the server may select an advertisement related to an offering available local to the departure point of the flight (step 423). In such a case, the table 300 of FIG. 3 can be disregarded, or at least, advertisements of local vendors can be interspersed with the advertisements selected from the table 300.

However, if no delay is received, the server may select an advertisement related to a destination corresponding to the aggregation of people (step 425). Such a selection may be made by referencing table 300 of FIG. 3, and locating, with reference first to the destination, and then to the target demographic, a target demographic that most closely matches the aggregated population characteristic. Alternatively, the selection may be one of several advertisements that are within a tolerable similarity to the aggregated population characteristic. If multiple advertisements match, within acceptable tolerances, such advertisements, may be rotated.

Next, after steps 423 or 425, the server may dispatch the selected advertisement to an advertisement portal (step 431). Similarly, if a condition that formerly was true no longer remains true, due to check-ins, check-outs or both, then such formerly selected advertisements may be withdrawn from the advertisement portal. Thus, there may be a pool of allowable advertisements that are dispatched to the advertisement portal, but not yet withdrawn. This pool of advertisements may be rotated in series or randomly, to provide viewers some variety. In the example shown, for a flight that arrives in Las Vegas on Saturday at 5 PM or a tolerable range approximate to 5 PM, three advertisements match, namely, Blue Man Group, Amazing Jonathan, and Penn & Teller. These advertisements can be dispatched in series to the advertisement portal, or dispatched to the advertisement portal as a batch, which the advertisement portal may render in sequence. Note that tolerable ranges can be a absolute tolerance preset by the airline or other server operator.

Further sub-steps can permit the server to send the one or more selected advertisements to an advertisement portal that is a mobile advertisement portal. The server can detect a presence of a mobile advertisement portal, such as mobile advertisement portal 233 of FIG. 2 that is associated with the flight, for example, the flight for which the first check-in is received. The presence is detected when the mobile advertisement portal reports, for example, wirelessly, that it is within a radius of the jet-way, aircraft, or other landmark associated with the flight. The presence information can rely on GPS data detected at the mobile advertisement portal. Accordingly, in response to such a presence, the server can dispatch the at least one advertisement to the service vehicle for rendering and such dispatching. Processing may terminate thereafter.

Alternate embodiments, instead of receiving a check-out at step 413, may establish a presumptive check-out in lieu of any rigorous check out. A presumptive check-out can be a time difference from a check-in that, on the basis of an algorithm, determines that the person checked-in has probably departed from the service location. For example, a presumptive check-out is a timer that expires and further processing may resume at step 415 in this alternative embodiment. This embodiment can be used when overt checking out is, as described above, is not feasible. Such a situation can include the use of a health club, where members are required to check in but do not typically check out. An algorithm can be described as setting a timer to 45 minutes for any member who is 45 years or older, and setting a timer to 75 minutes for any member who is younger than 45 years old. The specific time durations may be set based on experiences, and may be more finely graduated to specific age ranges of members.

Further alternative embodiments may be implemented in environments not associated with travel. As described above, a health club is an example. Further examples include aggregations of people at doctor's offices, dentist's offices, and restaurant waiting areas, each of which has a natural gating function where a check-in kiosk could be placed to collect presence details.

In the instance of a waiting room full of patients, vital statistics such as medical conditions could be aggregated to determine if a minimal percentage of checked-in and waiting patients possess a specific medical condition. Such a determination could be made by referencing a repository owned or controlled by the treating medical practice. In other words, when a person is registered as checked-in, the kiosk can indicate to a server to increment a tally of people with one or more medical conditions. Similarly, when a person is checking-out, the sum of people with the medical condition of that person can be decremented. A criteria for the rendering of a blood pressure advertisement may be that over 33% of checked-in patients are indicated as having the medical condition ‘high blood pressure’.

Accordingly, one or more embodiments may establish an aggregated population characteristic for aggregations of people who are present, and for whom reasonably accurate vital statistics are available. Such embodiments can account for checking out of people who were checked in, and revising the aggregated population characteristic in response thereto. Such an aggregated population characteristic can be used to select suitable advertising that will appeal at least to some members of a targeted demographic. Moreover, by relying on information concerning a group's destination, a subset of all advertising can be selected that directly relates to the destination. In addition, if unexpected delays are detected, the mixture of advertising can be responsively shifted to relate information concerning amenities present at or near the aggregation of people.

As may be appreciated, the embodiments can be used any place where people are systematically added and either wait, or perform a function within a relatively closed environment. As such, any place where people queue and for which people may register their presence may be amenable to application of one or more embodiments.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or computer readable tangible storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A computer implemented method for selecting advertising, the computer implemented method comprising:
receiving an advertisement;
receiving a target demographic description corresponding to the advertisement;
receiving a destination information corresponding to the advertisement, wherein destination information is a description of a point in an itinerary;
storing the advertisement and target demographic to an advertising repository a server receiving a first check-in corresponding to at least one person, wherein a check-in is an indication of presence;
the server receiving a second check-in to form an aggregation of people;
the server characterizing the aggregation based on cumulative characteristics selected from at least one of the group consisting of age, marital status, and parental status associated with at least one of the first check-in and second check-in to form an aggregated population characteristic;
the server selecting at least one advertisement based on the aggregated population characteristic; and
the server dispatching the at least one advertisement.

2. The computer implemented method of claim 1, the computer implemented method further comprising:
receiving a check-out of at least one person, wherein the check-out comprises reading an identifier of the person;
discarding vital statistics corresponding to the at least one person; and
second characterizing the aggregation based on the cumulative characteristics.

3. The computer implemented method of claim 1, wherein check-in comprises:
receiving a record locator; and
looking up vital statistics from a repository based on the record locator for at least one person.

4. (canceled)

5. The computer implemented method of claim 1, further comprising:
receiving flight details wherein selecting the advertisement is based on flight details.

6. The computer implemented method of claim 5, wherein the flight details comprise one selected from the group consisting of destination, arrival time, flight identifier and delay status.

7. The computer implemented method of claim 6, wherein delay status is minutes reported by airline authorities.

8. A computer program product for selecting advertising, the computer program product comprising:
a computer usable tangible storage device, which is not a propagating transient signal, having computer usable program code embodied therewith, the computer program product comprising:
computer usable program code configured to receive a first check-in corresponding to at least one person, wherein a check-in is a indication of presence;
computer usable program code configured to receive a second check-in to form an aggregation of people;
computer usable program code configured to characterize the aggregation based on cumulative characteristics selected from at least one of the group consisting of age, marital status, and parental status associated with at least one of the first check-in and second check-in to form an aggregated population characteristic;
computer usable program code configured to receive a check-out of at least one person, wherein the check-out comprises reading an identifier of the person;
computer usable program code configured to discard at least one vital statistic corresponding to the at least one person to form a second cumulative characteristic, in response to check-out of the at least one person;
computer usable program code configured to select at least one advertisement based on the second cumulative characteristic; and
computer usable program code configured to dispatch the at least one advertisement.

9. (canceled)

10. The computer program product of claim 8, wherein computer usable program code configured to receive the first check-in comprises:
computer usable program code configured to receive a record locator; and
computer usable program code configured to look up vital statistics from a repository based on the record locator for at least one person.

11. The computer program product of claim 8, the computer usable program code further configured to:
receive an advertisement;
receive a target demographic description corresponding to the advertisement;
receive a destination information corresponding to the advertisement; and
store the advertisement and target demographic to an advertising repository.

12. The computer program product of claim 8, the computer usable program code further configured to:
receive flight details, wherein computer usable program code configured to select the advertisement is based on flight details.

13. The computer program product of claim 12, wherein the flight details comprise one selected from the group consisting of destination, arrival time, flight identifier and delay status.

14. A data processing system for selecting advertising, the data processing system comprising:
a hardware processor, a computer readable memory and a computer readable storage device;
first program instructions to receive a first check-in corresponding to at least one person, wherein a check-in is a indication of presence;
second program instructions to receive a second check-in to form an aggregation of people;
third program instructions to characterize the aggregation based on cumulative characteristics selected from at least one of the group consisting of age, marital status, and parental status associated with at least one of the first check-in and second check-in to form an aggregated population characteristic;
fourth program instructions to receive a check-out of at least one person, wherein the check-out comprises reading an identifier of the person;
fifth program instructions to discard at least one vital statistic corresponding to the at least one person to form a second cumulative characteristic;
sixth program instructions to select at least one advertisement based on the second cumulative characteristic; and
seventh program instructions to dispatch the at least one advertisement, wherein the first, second, third, fourth, fifth, sixth and seventh program instructions are stored on the computer readable tangible storage device for execution by the hardware processor via the computer readable memory.

15. (canceled)

16. The data processing system of claim 14, wherein check-in comprises:
eighth program instructions to receive a record locator; and
ninth program instructions to look up vital statistics from a repository based on the record locator for at least one person.

17. The data processing system method of claim 14, wherein the computer implemented method further comprises:
eighth program instructions to receive an advertisement;
ninth program instructions to receive a target demographic description corresponding to the advertisement;
program instructions to receive a destination information corresponding to the advertisement; and
program instructions to store the advertisement and target demographic to an advertising repository.

18. The data processing system of claim 14, further comprising:
eighth program instructions to receive flight details, wherein selecting the advertisement is based on flight details.

19. The data processing system of claim 18, wherein the flight details comprise one selected from the group consisting of destination, arrival time, flight identifier and delay status, wherein the delay status is the minutes reported by airline authorities.

20. The data processing system of claim 14, further comprising:
eighth program instructions to detect presence of a service vehicle associated with a flight,wherein fifth program instructions to dispatch comprises instructions to dispatch the at least one advertisement to the service vehicle for rendering and such dispatching is responsive to detecting presence of the service vehicle.
